(19) United States
(12) Patent Application Publication
(10) Pub. No.: US 2016/0135246 A1
(43) Pub. Date: May 12, 2016

(54) HANDLING OF DEVICE-TO-DEVICE COMMUNICATIONS INTEREST INDICATION

(71) Applicant: Microsoft Corporation, Redmond, WA (US)

(72) Inventor: Haitao Li, Beijing (CN)

(21) Appl. No.: 14/564,870

(22) Filed: Dec. 9, 2014

(30) Foreign Application Priority Data
Nov. 6, 2014 (CN) PCT/CN2014/090453

(51) Int. Cl. H04W 76/02

(52) U.S. Cl. CPC H04W 76/028; H04W 76/023

(57) ABSTRACT

This disclosure generally relates to handling of device-to-device communication interest indication. In one embodiment, a D2D UE may receive at its lower layer one or more first indicator for D2D communication interest indication from its higher layer during a time period of disconnection with its serving base station. The UE generates a second indicator for D2D communication interest indication based on the received first indicator(s). The second indicator is used to record or represent the latest first indicator for the UE's D2D communication interest indication received during the time period of disconnection. Once the connection with a base station is successfully reestablished, the UE reports to the re-established base station the generated second indicator to inform its D2D communication interest.

### RELATED APPLICATIONS

This application claims priority to International Application No. PCT/CN2014/090453, filed on Nov. 6, 2014, and entitled “HANDLING OF DEVICE-TO-DEVICE COMMUNICATIONS INTEREST INDICATION.” This application claims the benefit of the above-identified application, and the disclosure of the above-identified application is hereby incorporated by reference in its entirety as if set forth herein in full.

### BACKGROUND

Major effort has been put in recent years on the development of Third Generation Partnership Project (3GPP) Long Term Evolution (LTE), which provides Evolved Universal Mobile Telecommunications System (UMTS) terrestrial radio access (EUTRA) and EUTRA network (EUTRAN) technology for higher data rates and system capacity. In 3GPP LTE-Advanced (LTE-A) cellular systems, device-to-device (D2D) communication has been proposed to enable Proximity-based Service (ProSe). Compared to legacy cellular communication which happens between User Equipments (UEs) and networks, D2D communication enables direct link communication between UEs and thus has the potential benefits of UE power saving due to short transmission distance, efficient radio resource reuse and offloading network's burden.

3GPP Rel-12 Work Item “Study on Proximity-based Services” is designed to address both critical communications and commercial requirements for proximity (also referred as to “D2D”) services on LTE. In Rel-12, 3GPP studies, mainly for public safety use cases, broadcast based direct link D2D communication without introducing any feedback between devices. On frequency/carrier support, 3GPP has assumed for Rel-12 that all ProSe communication for a D2D-capable UE is performed on a single ProSe carrier, which is pre-configured and known to the UE. A network controlled inter-frequency handover approach is adopted to switch a D2D-interested UE to its preferred ProSe carrier under the control of the serving base station of the D2D-interested UE.

More specifically, a Radio Resource Control (RRC) CONNECTED UE needs to send a message to its serving base station to indicate its ProSe communication interest (also referred to as “D2D communication interest), for example, when the user of the UE wants to perform ProSe communication through a proximity-based social networking application. This indication message contains the pre-configured ProSe carrier that the UE intends to use in the ProSe communication. The serving base station may then configure an inter-frequency Radio Resource Management (RRM) measurement on the ProSe carrier and based on the measurement report trigger inter-frequency mobility to that ProSe carrier once the UE enters coverage on a cell on the ProSe carrier. This is also known as a load balancing approach which is not necessarily caused by UE's mobility.

### SUMMARY

However, during UE mobility, D2D communication interest indication message issued by the UE to its serving cell may be missed out due to radio link failure (RLF). As a consequence, a mismatch in D2D communication interest happens between the UE and the base station. It will leads to issues such as no load balancing happening to the ProSe carrier or unexpected proximity services being triggered in the ProSe carrier.

In accordance with embodiments of the subject matter described herein, a D2D UE may receive at its lower layer one or more first indicator for D2D communication interest indication from its higher layer during a time period of disconnection with its serving base station. The UE generates a second indicator for D2D communication interest indication based on the received first indicator(s). The second indicator is used to record or represent the latest first indicator for the UE's D2D communication interest indication received during the time period of disconnection. Once the connection with a base station is successfully reestablished, the UE reports to the re-established base station the generated second indicator to inform its D2D communication interest. In one embodiment of the subject matter described herein, the second indicator may be included in a RRC connection reestablishment complete message. In another embodiment of the subject matter described herein, the UE may send an additional RRC signaling message to the second base station after a RRC connection reestablishment complete message to contain the second indicator.

In this way, even in the situation that the UE experiences a link failure with its serving base station during its mobility, the latest D2D communication interest, either positive or negative interest, can be stored and reported to the re-established base station after connection re-establishment is completed. As such, the re-established base station can obtain appropriate information on the UE's D2D communication interest and thus can perform load balance to move the UE to the proper ProSe carrier, whereby user experience will be improved in the terminal side.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 illustrates a block diagram of user equipment in accordance with one embodiment of the subject matter described herein;

FIG. 2 illustrates a block diagram of an environment in which embodiments of the subject matter described herein may be implemented;

FIGS. 3A and 3B illustrate block diagrams of two exemplary scenarios in which D2D interest mismatch may be happened between UE and BS;

FIG. 4 illustrates a flowchart of a method for handling D2D communication interest indication in accordance with one embodiment of the subject matter described herein;

FIG. 5 illustrates one example of a Radio Resource Control (RRC) Connection Reestablishment Complete message that includes a second indicator for D2D communication interest indication in accordance with one embodiment of the subject matter described herein;

FIG. 6 illustrates one example of signaling flow between UE and BS(s) in accordance with one embodiment of the subject matter described herein; and

FIG. 7 illustrates a block diagram of an apparatus for handling D2D communication interest indication in accordance with one embodiment of the subject matter described herein.

### DETAILED DESCRIPTION

The subject matter described herein will now be discussed with reference to several example embodiments. It should be understood these embodiments are discussed only for the purpose of enabling those skilled persons in the art to better understand and thus implement the subject matter described herein, rather than suggesting any limitations on the scope of the subject matter.

As used herein, the term “base station” (BS) may represent a node B (NodeB or NB), an evolved NodeB (eNodeB or eNB), a Remote Radio Unit (RRU), a radio header (RH), a remote radio head (RRH), a relay, a low power node such as a femto, a pico, and so forth.

As used herein, the term “user equipment” (UE) may refer to any device that is capable of communicating with the BS. By way of example, the UE may include a terminal, a Mobile Terminal (MT), a Subscriber Station (SS), a Portable Subscriber Station (PSS), a Mobile Station (MS), or an Access Terminal (AT). For the purpose of simplicity, the term “D2D UE” refers to a UE enabling the ProSe (also referred to as “D2D”) communications hereafter.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

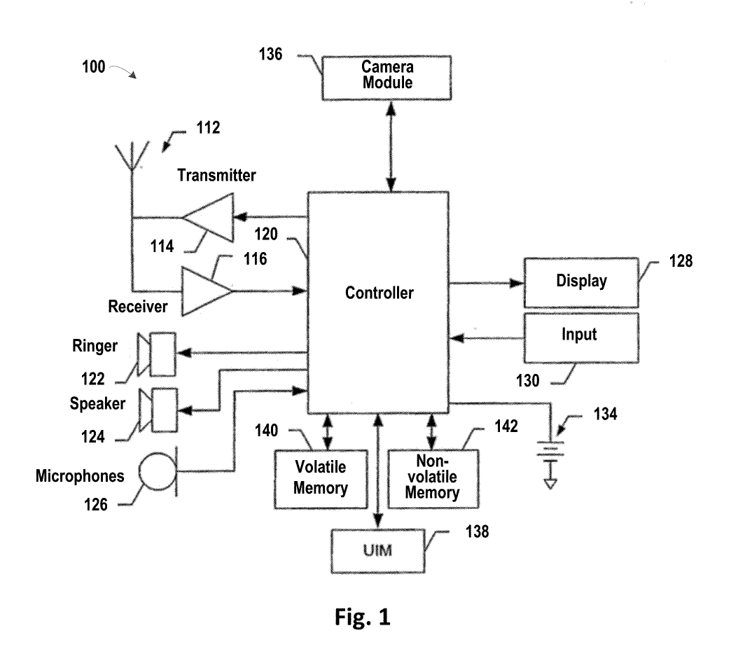

FIG. 1 illustrates a block diagram of a UE 100 in accordance with one embodiment of the subject matter described herein. The UE 100 may be a mobile device with a wireless communication capability. However, it is to be understood that any other types of user devices may also easily adopt embodiments of the subject matter described herein, such as a portable digital assistant (PDA), a pager, a mobile computer, a mobile TV, a game apparatus, a laptop, a tablet computer, a camera, a video camera, a GPS device, and other types of voice and textual communication system. A fixed-type device may likewise easily use embodiments of the subject matter described herein.

As shown, the UE 100 comprises one or more antennas 112 operable to communicate with the transmitter 114 and the receiver 116. With these devices, the UE 100 may perform cellular communications with one or more BSs. Additionally, the UE 100 may be a D2D UE that supports the D2D communications with one or more other UEs.

The UE 100 further comprises at least one controller 120. It should be understood that the controller 120 comprises circuits or logic required to implement the functions of the user terminal 100. For example, the controller 120 may comprise a digital signal processor, a microprocessor, an A/D converter, a D/A converter, and/or any other suitable circuits. The control and signal processing functions of the UE 100 are allocated in accordance with respective capabilities of these devices.

The UE 100 may further comprise a user interface, which, for example, may comprise a ringer 122, a speaker 124, a microphone 126, a display 128, and an input interface 130, and all of the above devices are coupled to the controller 120. The UE 100 may further comprise a camera module 136 for capturing static and/or dynamic images.

The UE 100 may further comprise a battery 134, such as a vibrating battery set, for supplying power to various circuits required for operating the user terminal 100 and alternatively providing mechanical vibration as detectable output. In one embodiment, the UE 100 may further comprise a user identification module (UIM) 138. The UIM 138 is usually a memory device with a processor built in. The UIM 138 may for example comprise a subscriber identification module (SIM), a universal integrated circuit card (UICC), a universal user identification module (USIM), or a removable user identification module (R-UIM), etc. The UIM 138 may comprise a card connection detecting apparatus according to embodiments of the subject matter described herein.

The UE 100 further comprises a memory. For example, the UE 100 may comprise a volatile memory 140, for example, comprising a volatile random access memory (RAM) in a cache area for temporarily storing data. The UE 100 may further comprise other non-volatile memory 142 which may be embedded and/or movable. The non-volatile memory 142 may additionally or alternatively include for example, EEPROM and flash memory, etc. The memory 140 may store any item in the plurality of information segments and data used by the UE 100 so as to implement the functions of the UE 100. For example, the memory may contain machine-executable instructions which, when executed, cause the controller 120 to implement the method described below.

It should be understood that the structural block diagram in FIG. 1 is shown only for illustration purpose, without suggesting any limitations on the scope of the subject matter described herein. In some cases, some devices may be added or reduced as required.

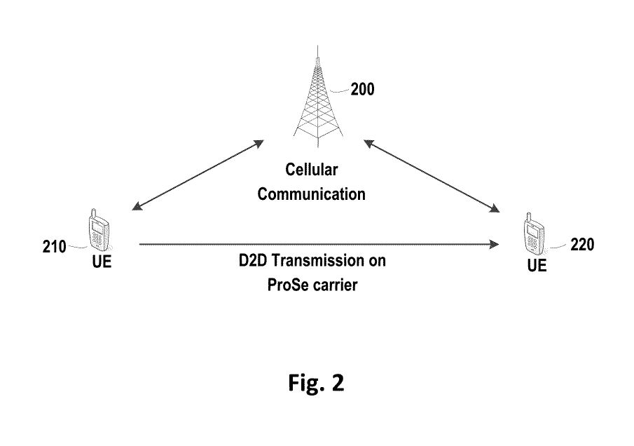

FIG. 2 shows an environment of a cellular system in which embodiments of the subject matter described herein may be implemented. As shown, one or more UEs may communicate with a BS 200. In this example, there are two UEs 210 and 220. This is only for the purpose of illustration without suggesting limitations on the number of UEs. There may be any suitable number of UEs in communication with the BS 200. In one embodiment, the UEs 210 and/or 220 may be implemented by the UE 100 as shown in FIG. 1, for example.

The cellular communications between the UEs 210 and 220 and the BS 200 may be performed according to any appropriate communication protocols including, but not limited to, the first generation (1G), the second generation (2G), 2.5G, 2.75G, the third generation (3G), the fourth generation (4G) communication protocols, and/or any other protocols either currently known or to be developed in the future.

As mentioned above, under currently agreed architecture, in order to enable the BS 200 to move appropriately a D2D-interested UE, for example the UE 210 to its intended ProSe carrier, it is important that the UE 210 informs the BS 200 of a D2D communication interest indication, when it does or does not want to perform ProSe communication. This may be called “trigger-1”, which has been adopted by D2D UEs and implemented in a lower layer such as an access stratum layer of UEs. The triggering event may be, for example, an event in a higher layer (such as an application layer) of the UE 210, for example, a request from a user of the UE 210 that initiates a D2D connection or cancel a D2D connection. The D2D communication interest indication may indicate either a positive interest in ProSe communication or a negative interest in ProSe communication. If the UE 210 reports to the BS 200 a positive D2D communication interest indication, it will serves as the trigger for network to perform preferred load balancing to the ProSe carrier of the UE 210. Otherwise, if the UE 210 reports to its serving BS a negative D2D communication interest indication, the BS 200 should not attempt to move the UE 210 to the ProSe carrier, especially for the case of a dedicated National Security & Public Safety (NSPS) carrier serving the ProSe carrier. That is because the dedicated NSPS carrier may not well provision normal cellular services and moving the UE 210 to the ProSe carrier might ruin user's cellular service experience.

It should be noted that, even if the D2D-interest UE 210 can indicate a positive interest in ProSe communication to the BS 200, it does not mean that the UE 210 can always expect an immediate action of moving to the ProSe carrier and starting the ProSe communication. The reasons could be:
Load balancing for connected mode UEs is controlled by network, for example, the BS 200. Inter-frequency measurement is sometimes UE capability limited (e.g. the UE 210 has been configured with quite many inter-frequency measurements and may not afford additional inter-frequency measurement if not impacting current ones) and measurement report will also take some time. In addition, load balancing is subject to BS's Radio Resource Management (RRM) strategy. In some cases, the outcome of RRM algorithm may prefer to maintain cellular traffic rather than ProSe traffic.
UE's D2D communication interest is not based on or has nothing to do with physical radio condition. It is quite likely that, even with a positive D2D communication interest indication, the UE 210 is indeed not in the coverage of the ProSe carrier. In that case, load balancing to the ProSe carrier will not happen. In this case, the BS 200 can only keep the UE 210's positive D2D communication interest indication and make preferred load balance in future attempts when the UE 210 enters into the coverage of the ProSe carrier.

When the UE is moving through a cell or across cells, a mismatch in D2D communication interest may happen between the UE and the BS(s). D2D communication interest indication message issued by the UE may be missed out and cannot be known by a proper BS, due to the UE's disconnection with network. One exemplary event that results in the disconnection condition is Radio Link Failure (RLF).

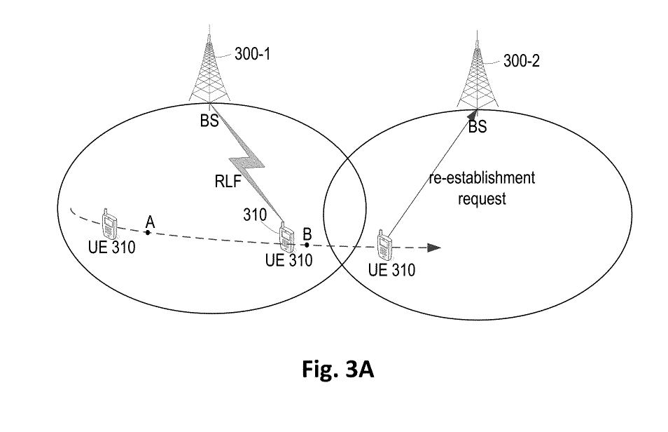

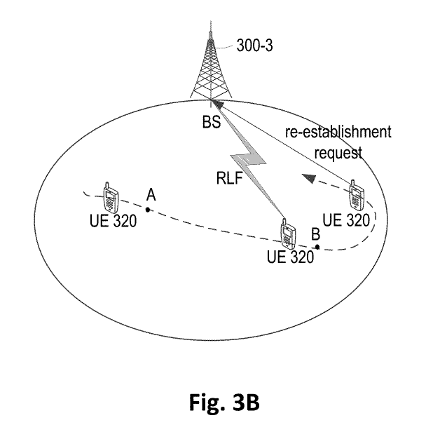

FIGS. 3A and 3B illustrate block diagrams of two exemplary scenarios in which D2D interest mismatch may be happened between UE and BS(s).

As shown in FIG. 3A, a UE 310 moves along the dotted line. The UE 310 reports to its serving BS 300-1 a negative D2D communication interest indication at time point A. After that, during UE mobility, the UE 310 experiences RLF with its serving cell and then triggers connection re-establishment procedure. During the time period of disconnection, at time point B, the UE 310's higher layer internally triggers the positive D2D interest in ProSe communication. However, the UE 310 has lost connection with the serving BS 300-1 and will not be able to report this positive D2D communication interest indication to the serving cell. After the UE 310 successfully re-establishes connection either in the previous serving cell (not shown in FIG. 3A) or in a different cell of a BS 300-2 (as shown in FIG. 3A), the re-established BS, such as BS 300-2 as shown in FIG. 3A, will not have the UE 310's positive D2D communication interest indication and may not switch the UE 310 to the ProSe carrier as preferred by the UE 310.

FIG. 3B shows another scenario. As shown in FIG. 3B, a UE 320 moves along the dotted line. The UE 320 reports a positive D2D communication interest indication to its serving BS 300-3. However, it is very likely that there is no immediate expected load balancing happening to the ProSe carrier due to reasons as discussed above. After that, during UE mobility, the UE 320 experiences RLF with its serving cell and then triggers connection re-establishment procedure. The UE 320 attempts connection re-establishment. At time point B, the UE 320's higher layer internally triggers a negative D2D interest in ProSe communication. However, due to RLF, both the previous serving BS and the re-established BS (in FIG. 3B, the re-established BS is the previous serving BS 300-3) cannot receive such indication. If the UE re-establishes to the previous serving BS 300-3, the BS 300-3 may still regard the UE 320 as having positive D2D communication interest and attempt to switch the UE 320 to the ProSe carrier. However, such D2D communication on the ProSe carrier may be unexpected to the UE 320, as the ProSe carrier may not provide as good cellular services as common LTE cellular carrier. In addition, it is wasting of resource that the UE 320 is actually not using ProSe services provided in the ProSe carrier.

These D2D interest mismatch issues need to be solved if operators really intend to smoothly integrate ProSe services into cellular LTE system. Embodiments of the subject matter described herein aim to provide a solution to at least partially solve the problems discussed above.

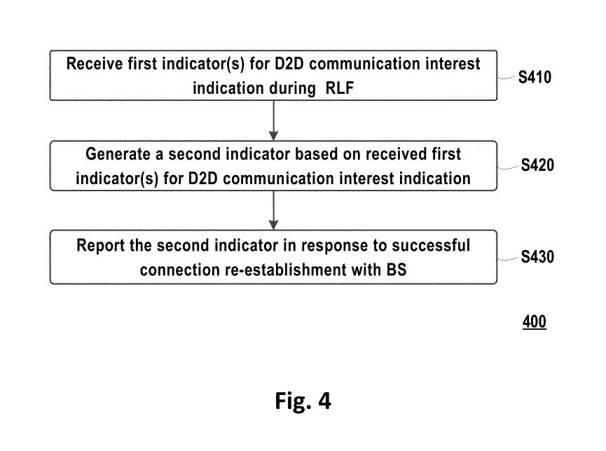

With reference to FIGS. 4-7, various embodiments of the subject matter described herein are set forth in detail.

FIG. 4 illustrates a flowchart of a method 400 for handling D2D communication interest indication in accordance with one embodiment of the subject matter described herein. The method 400 may be at least in part implemented by a D2D UE, for example, UE 210, 220, 310 or 320.

A D2D UE moves within or across its serving cell. During the UE's mobility, the UE may be disconnected with its serving BS, for example, due to RLF. According to one embodiment of the subject matter described herein, the process of FIG. 4 may start once the UE detects the disconnection with the serving BS. As shown in FIG. 4, in step S410, the D2D UE receives at its lower layer at least one first indicator for D2D communication interest indication from its higher layer, during the time period of disconnection. The received first indicator(s) cannot be reported from the UE to the serving BS, because the connection therebetween has lost. In order to maintain the first indicator(s) for D2D communication interest indication that is generated during the time period of disconnection, a second indicator for D2D communication interest indication may be initiated in the lower layer, for example, a access stratum layer, in response to the detection of the disconnection. In step S420, the UE generates the second indicator for D2D communication interest indication based on the received first indicator(s), and the second indicator is used to record or represent the latest first indicator. Once the connection with a BS is successfully reestablished, in step S430, the UE reports to the re-established BS the generated second indicator to inform its D2D communication interest. In this way, the re-established BS will not miss the latest indicator for D2D communication interest indication from the higher layer, such as a non-access stratum layer, even if such D2D communication interest indication is made by a user of the UE during the time period of disconnection.

In an alternative embodiment of the subject matter described herein, the second indicator may be initiated at very beginning and configured to record the newest first indicator, no matter whether there is RLF that happen between the UE and BS. If the second indicator is successfully reported to the serving BS, it may be reset into Null to indicate that no first indicator for D2D communication indication is received. Otherwise, the second indicator is configured to represent the latest first indicator for D2D communication interest that receives from the higher layer of the UE. When the UE experiences a RLF with the serving BS, the latest first indicator for D2D communication interest indication cannot be missed due to the use of the second indicator. This embodiment will be advantageous particularly for dealing with the case that the latest D2D communication interest indication from the higher layer of the UE is received within a so short period, e.g. a couple of milliseconds prior to the start of RLF that it cannot be sent to the BS. However, since it cannot be expected when the disconnection between the UE and the BS occurs, the UE has to maintain a variable of the second indicator in the lower layer for a relatively long time, for example, during the whole period when the D2D application is active in the UE. In this sense, such an embodiment may not be cost effective.

In the various embodiments of the subject matter described herein, once connection is re-established successfully, the UE will inform the re-established BS of the newest D2D communication interest indication by sending to the re-established BS the second indicator. Note that, this also means defining a new trigger for D2D interest indication in specification, which may be call “trigger-2” and is different from the “trigger-1” as mentioned above. Trigger-1 corresponding to the first indicator is coming from a higher layer (e.g. a non-access stratum layer) of the UE, while trigger-2 corresponding to the second indicator is implemented in a low layer (e.g., an access stratum layer”, which may be, for example, based on a RRC signalling message.

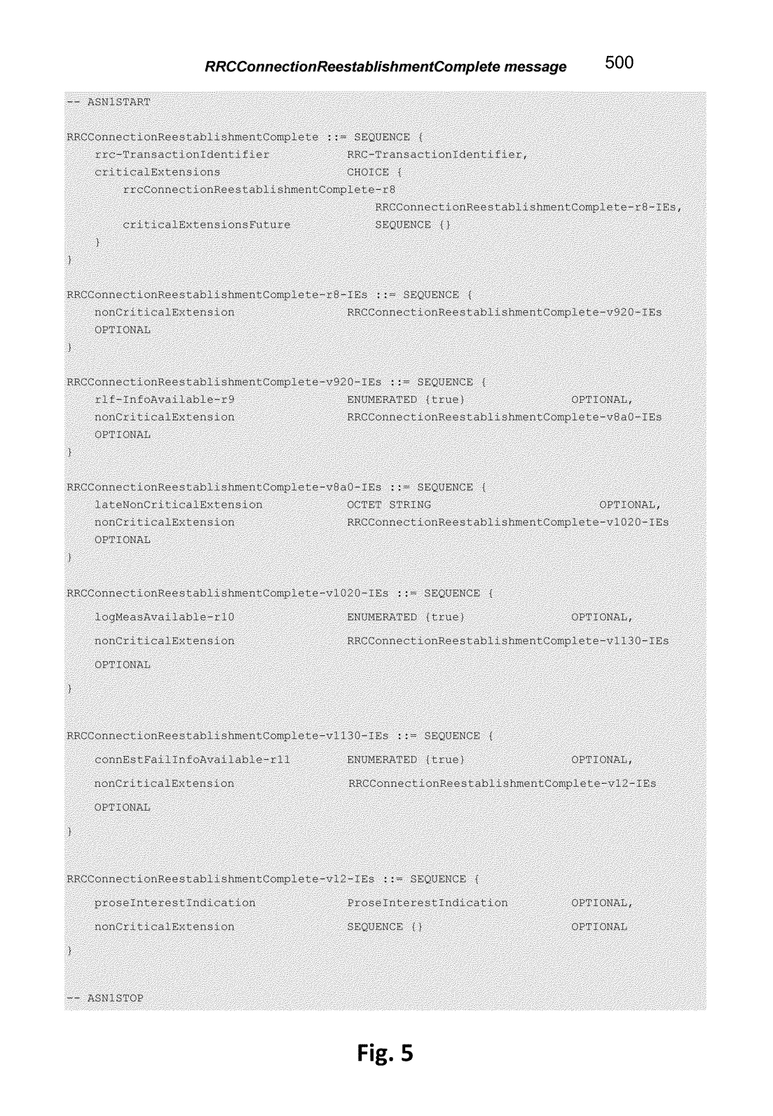

According to an embodiment of the subject matter described herein, after the connection is reestablished between the UE and BS (either the previous serving BS or a new serving BS), the second indicator may be reported to the BS by sending a RRC connection reestablishment complete message including the second indicator. FIG. 5 illustrates one example of a Radio Resource Control (RRC) Connection Reestablishment Complete message 500 that includes a second indicator for D2D communication interest indication in accordance with one embodiment of the subject matter described herein. As illustrated in FIG. 5, a new Information Element (IE) named “RRCConnectionReestablishmentComplete-v12-IEs” is added for D2D communication interest indication. In the IE, the parameter “proseInterestIndication” can be assigned to the second indicator, so that the latest D2D communication interest, either positive interest or negative interest, can be reported to the re-established BS.

In an alternative embodiment of the subject matter described herein, the UE may send an additional RRC signaling message to the second BS after a RRC connection re-establishment complete message to contain the second indicator.

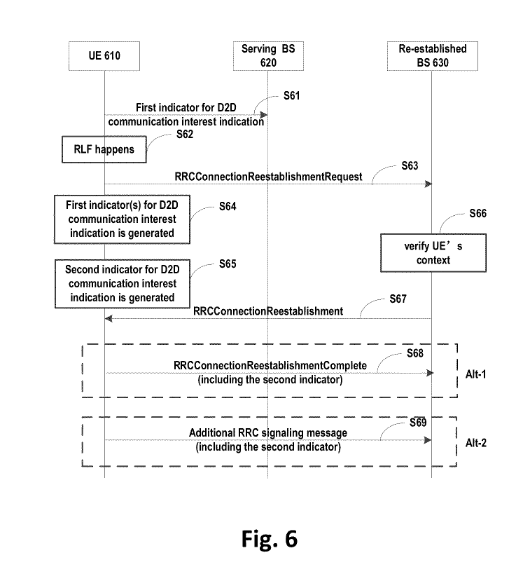

FIG. 6 illustrates one example of signaling flow between UE and BS(s) in accordance with one embodiment of the subject matter described herein.

In the example as shown in FIG. 6, in step S61, a UE 610 communicates with its serving BS 620. A first indicator for D2D communication interest indication is generated at the higher layer of the UE 610, for example, when the user of the UE 610 instructs to perform ProSe communication through a proximity-based social networking application. In step S61, the UE 610 reports the first indicator to the serving BS 620 through the established radio link with the BS 620. In step S62, the UE 610 detects that RLF with the serving BS 620 happens due to the mobility of the UE 610 and then initiates the connection reestablishment procedure by sending, in step S63, a RRC Connection Reestablishment Request message to an appropriate BS 630. In the example of FIG. 6, although the re-established BS 630 is shown as a different BS from the previous serving BS 620, those skilled in the art that the re-established BS may also be the same BS as the previous serving BS in some other examples.

In one embodiment, once the UE 610 detects the RLF a variable may be initiated in the RRC layer for the second indicator to store the latest first indicator for D2D communication interest indication. As an alternative, the variable for the second indicator may also be initiated in the RRC layer at earlier stage and maintained for the whole period when the proximity-based social networking application is active, for example. As shown in FIG. 6, during the time period of disconnection, in step S64, at the application layer of the UE 610, a further first indicator for D2D communication interest indication is generated by the user. However, such first indicator cannot be reported to the serving BS 620 due to the RLF. In step S65, a second indicator for D2D communication interest indication is generated in the RRC layer, which is used to store or record the latest first indicator received from the application layer.

After receiving the RRC Connection Reestablishment Request message, just like the conventional connection re-establishment procedure, the re-established BS 630 verifies the UE 610's context in step S66. If the re-established BS 630 successfully verifies the UE 610, it sends back, in step S67, a RRC Connection Reestablishment message to inform the UE 610 of the reestablishment of the new radio link between the UE 610 and BS 630.

Upon receipt of the RRC Connection Reestablishment message from the re-established BS 630, as a feedback, the UE 610 needs to send, in step S68, to the BS 630 a RRC Connection Request Reestablishment Complete message, to terminate the connection reestablishment procedure. According to an embodiment of the subject matter described herein, the second indicator may be included in the RRC Connection Reestablishment Complete message to report to the re-established BS 630. An example of the RRC Connection Reestablishment Complete message that includes the second indicator for D2D communication interest indication is illustrated in FIG. 5.

According to an alternative embodiment of the subject matter as described herein, in step S69, an additional RRC signaling message including the second indicator may send to the re-established BS 630, after the RRC Connection Reestablishment Complete message is sent.

It can be seen that although the UE 610 once disconnected with the network due to RLF, the newest D2D communication interest generated from the higher layer (e.g., the application layer) of the UE 610 is not missed by the re-established BS 630 after the connection reestablishment procedure. As such, the re-established BS 630 can obtain appropriate information on the UE 610's D2D communication interest and thus can perform load balance to move the UE 610 to the proper ProSe carrier, whereby user experience will be improved in the terminal side.

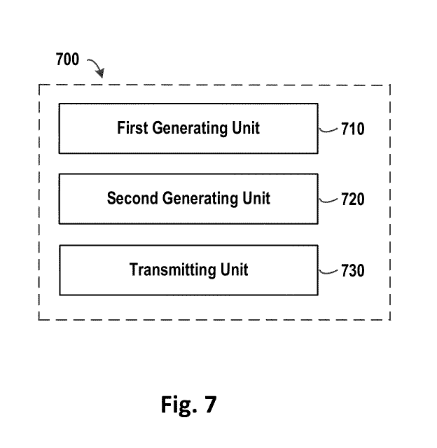

FIG. 7 illustrates a block diagram of an apparatus 700 for handling D2D communication interest indication in accordance with one embodiment of the subject matter described herein. In one embodiment, the apparatus 700 may be implemented as a D2D UE or can be implemented by using part of functionalities of a D2D UE, for example. As shown, the apparatus 700 comprises a first generating unit 710, a second generating unit 720, and a transmitting unit 730.

The first generating unit 710 is configured to generate, at a higher layer of the UE, at least one first indicator for D2D communication interest indication. The second generating unit 720 is configured to generate, at a lower layer of the UE, a second indicator for D2D communication interest indication based on at least one first indicator that is received from the higher layer but has not yet been reported to the serving BS, for example, the first indicator(s) received at the lower layer of the UE during a time period when the UE experiences disconnection with a first BS originally serving the UE. The second indicator represents the latest first indicator received. The transmitting unit 730 is configured to report, in response to successful connection re-establishment with a second BS, the generated second indicator to the second BS.

In one embodiment, the D2D communication interest indication is either a positive D2D communication interest indication or a negative D2D communication interest indication, which is generated by the first generating unit 710 at the higher layer of the UE. According to one embodiment, the higher layer of the user equipment is a non-access stratum layer.

The second generating 720 of the apparatus 700 may be implemented in the lower layer of the UE. According to one embodiment, the lower layer of the UE is an access stratum layer.

According to one embodiment of the subject matter as described herein, the transmitting unit 730 is configured to send to the second BS a Radio Resource Control (RRC) connection reestablishment complete message including the second indicator, thereby reporting to the second BS the latest first indicator for D2D communication interest indication that has not yet been reported, for example, due to RLF.

According to an alternative embodiment of the subject matter as described herein, the transmitting unit 730 is configured to send to the second BS an additional RRC signaling message including the second indicator, after a RRC connection reestablishment complete message is sent.

The units included in the apparatuses 700 may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses 700 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method, comprising:
receiving, from a higher layer of a user equipment, at least one first indicator for device-to-device (D2D) communication interest indication during a time period when the user equipment experiences disconnection with a first base station originally serving the user equipment;
generating a second indicator for D2D communication interest indication based on the received at least one first indicator, wherein the second indicator represents the latest first indicator; and
reporting, in response to successful connection re-establishment with a second base station, the generated second indicator to the second base station.

2. The method of claim 1, wherein the D2D communication interest indication is either a positive D2D communication interest indication or a negative D2D communication interest indication.

3. The method of claim 1, wherein the higher layer of the user equipment is a non-access stratum layer.

4. The method of claim 1, wherein the second indicator is implemented in an access stratum layer.

5. The method of claim 4, wherein reporting the generated second indicator comprises:
including the second indicator in a Radio Resource Control (RRC) connection reestablishment complete message.

6. The method of claim 4, wherein reporting the generated second indicator to the second base station comprises:
sending an additional RRC signaling message including the second indicator to the second base station, after a RRC connection reestablishment complete message is sent.

7. The method of claim 1, wherein the first base station is the same as the second base station,
wherein both the first and second base stations refer to the serving base station of the user equipment.

8. The method of claim 1, wherein the first base station is different from the second base station,
wherein the first base station refers to an original serving base station of the user equipment and the second base station refers to a new serving base station of the user equipment after the connection reestablishment.

9. A user equipment comprising:
a first generating unit configured to generate, at a higher layer of the user equipment, at least one first indicator for device-to-device (D2D) communication interest indication;
a second generating unit configured to generate, at a lower layer of the user equipment, a second indicator for D2D communication interest indication based on at least one first indicator that is received from the higher layer during a time period when the user equipment experiences disconnection with a first base station originally serving the user equipment, wherein the second indicator represents the latest first indicator; and
a transmitting unit configured to report, in response to successful connection re-establishment with a second base station, the generated second indicator to the second base station.

10. The user equipment of claim 9, wherein the D2D communication interest indication is either a positive D2D communication interest indication or a negative D2D communication interest indication.

11. The communication of claim 9, wherein the higher layer of the user equipment is a non-access stratum layer.

12. The user equipment of claim 9, wherein the lower layer of the user equipment is an access stratum layer.

13. The user equipment of claim 12, wherein the transmitting unit is configured to send to the second base station a Radio Resource Control (RRC) connection reestablishment complete message including the second indicator.

14. The user equipment of claim 12, wherein the transmitting unit is configured to send to the second base station an additional RRC signaling message including the second indicator, after a RRC connection reestablishment complete message is sent.

15. The user equipment of claim 9, wherein the user equipment is a user equipment capable of D2D communication.

16. A method, comprising:
receiving, from a higher layer of a user equipment capable of Proximity-based Service (ProSe) communication, at least one first indicator for ProSe communication interest indication during a time period when the user equipment experiences disconnection with a first base station originally serving the user equipment;
generating, at a Radio Resource Control (RRC) layer of the user equipment, a second indicator for ProSe communication interest indication based on the received at least one first indicator, wherein the second indicator represents the latest first indicator; and
reporting, in response to successful connection re-establishment with a second base station, the generated second indicator to the second base station via a RRC signaling message.

17. The method of claim 16, wherein the ProSe communication interest indication is either a positive ProSe communication interest indication or a negative ProSe communication interest indication.

18. The method of claim 1, wherein the higher layer of the user equipment is a non-access stratum layer.

19. The method of claim 16, wherein the RRC signaling message is a RRC connection reestablishment complete message.

20. The method of claim 16, wherein the RRC signaling message is an additional RRC signaling message following a RRC connection reestablishment complete message.
